(19) United States
(12) Patent Application Publication
(10) Pub. No.: US 2009/0257085 A1
(43) Pub. Date: Oct. 15, 2009

(54) GENERATION OF A WEB PAGE INCLUDING MENU ITEMS FOR WEB PAGES

(75) Inventor: Daisuke KONDO, Tokyo (JP)

Correspondence Address: IPUSA, P.L.L.C, 1054 31ST STREET, N.W., Suite 400, Washington, DC, 20007, US

(73) Assignee: RICOH COMPANY, LTD.

(21) Appl. No.: 12/412,543

(22) Filed: Mar. 27, 2009

(30) Foreign Application Priority Data
Apr. 9, 2008 (JP) 2008-101867

(51) Int. Cl. G06F 3/12; G06F 17/00

(52) U.S. Cl. 358/1.15; 715/205

(57) ABSTRACT

An image forming apparatus includes a plurality of Web page generating units each configured to perform processing responsive to an HTTP request and to generate a Web page for displaying information about a result of the processing; a menu information integrating unit configured to acquire from each of the Web page generating units information about URLs of the Web page generating units and information about menu items to be displayed for allowing the Web page generating units to be utilized, and configured to integrate the acquired information into a first storage file; and a menu page generating unit configured to generate based on the first storage file a Web page inclusive of the menu items for allowing Web pages generated by the Web page generating units to be utilized.

### BACKGROUND OF THE INVENTION

1. Field of the Invention

The disclosures herein generally relate to image forming apparatuses, image processing methods, and programs, and particularly relate to an image forming apparatus, image processing method, and program for providing a Web site.

2. Description of the Related Art

Conventionally, Web systems are widely used as infrastructure to allow the use of applications through networks. In Web systems, applications are implemented as Web applications running on a server computer that is referred to as a Web server or application server. Each Web application is assigned with a unique URL (Uniform Resource Locator). A client (i.e., Web browser or the like) sends an HTTP request by specifying a URL of a desired Web application, thereby causing a user interface (i.e., Web page) of the Web application to be displayed, or causing business logic implemented in the Web application to be executed.

In recent years, some image forming apparatuses such as copiers, printers, facsimile machines, and multifunctional machines have been designed to provide their functions through Web applications. With such image forming apparatuses, a user enters a URL of a desired function (i.e., Web application) into a Web browser or the like to utilize this desired function from a remote location.

An image forming apparatus is a single device from the user's viewpoint. Accordingly, it is desirable to create an environment in which an image forming apparatus is viewed by a user as a single Web site rather than a set of plural Web applications.

On the other hand, the independence of each Web application has been increasing due to the development of technology for providing software as components. As a result, it is now easy to add a new Web application in a flexible manner to an image forming apparatus for the purpose of improving functions.

Accordingly, it is desirable to create a Web site that not only appears as a single Web site into which plural Web applications are integrated, but also can flexibly cope with changes in the configuration of Web applications.

Accordingly, there is a need for an image forming apparatus, an information processing method, and a program that can integrate plural Web applications in a proper manner.

[Patent Document 1] Japanese Patent Application Publication No. 2004-318842

### SUMMARY OF THE INVENTION

It is a general object of at least one embodiment of the present invention to provide an image forming apparatus, an information processing method, and a program that substantially eliminate one or more problems caused by the limitations and disadvantages of the related art.

In one embodiment, an image forming apparatus includes a plurality of Web page generating units each configured to perform processing responsive to an HTTP request and to generate a Web page for displaying information about a result of the processing; a menu information integrating unit configured to acquire from each of the Web page generating units information about URLs of the Web page generating units and information about menu items to be displayed for allowing the Web page generating units to be utilized, and configured to integrate the acquired information into a first storage file; and a menu page generating unit configured to generate based on the first storage file a Web page inclusive of the menu items for allowing Web pages generated by the Web page generating units to be utilized.

According to at least one embodiment, an image forming apparatus, an information processing method, and a recording medium having a program stored therein that can integrate plural Web applications in a proper manner are provided.

### BRIEF DESCRIPTION OF THE DRAWINGS

Other objects and further features of embodiments will be apparent from the following detailed description when read in conjunction with the accompanying drawings, in which:

FIG. 1 is a drawing illustrating an example of the configuration of a program execution environment of an image forming apparatus according to a first embodiment;

FIG. 2 is a drawing illustrating an example of the configuration of bundles that provide an integrated Web site according to the first embodiment;

FIG. 3 is a drawing illustrating an example of a displayed menu page according to the first embodiment;

FIG. 4 is a drawing illustrating the process of generating an integration setting file and an integral menu file;

FIG. 5 is a drawing illustrating a procedure that is performed upon adding a Web UI content bundle according to the first embodiment;

FIG. 6 is a drawing illustrating an example of the configuration of a program execution environment of an image forming apparatus according to a second embodiment;

FIG. 7 is a drawing illustrating an example of the configuration of bundles that provide an integrated Web site according to the second embodiment;

FIG. 8 is a drawing illustrating exchange of information between Web UT framework bundles;

FIG. 9 is a drawing illustrating an example of a procedure that is performed upon receiving an HTTP request according to the second embodiment; and

FIG. 10 is a drawing illustrating a procedure that is performed upon adding a Web UI content bundle according to the second embodiment.

### DESCRIPTION OF THE PREFERRED EMBODIMENTS

In the following, embodiments of the present invention will be described with reference to the accompanying drawings. These embodiments will be described by using a multifunctional machine as an example of an image forming apparatus. A multifunctional machine is an image forming apparatus that provides plural functions such as a printer function, a copy function, a scanner function, and a facsimile function.

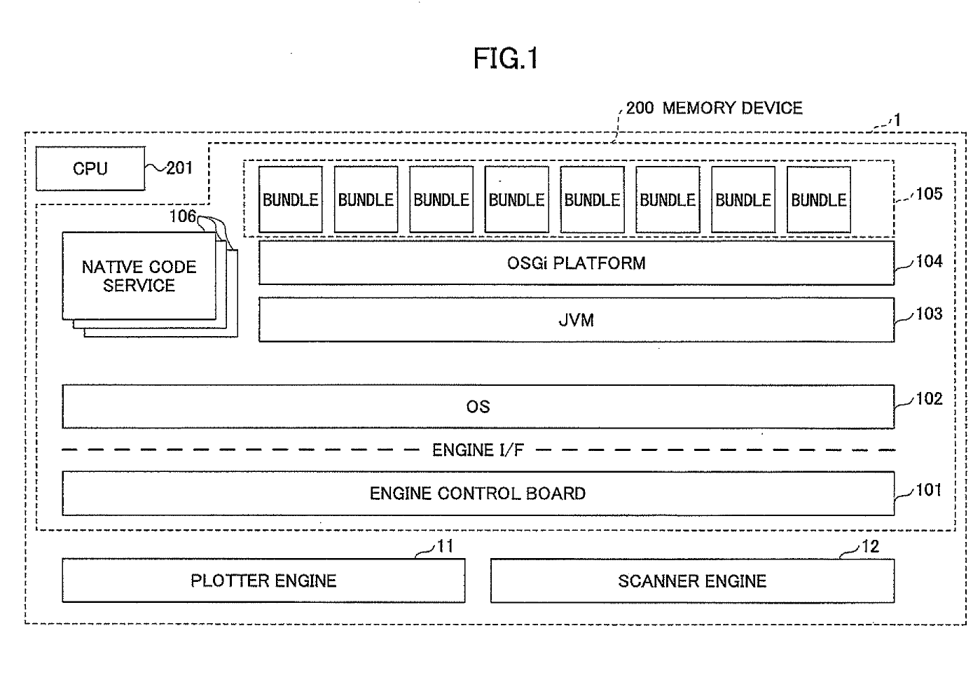

FIG. 1 is a drawing illustrating an example of the configuration of a program execution environment of an image forming apparatus according to a first embodiment.

The hardware resources of a multifunctional machine 1 illustrated in FIG. 1 include a plotter engine 11 and a scanner engine 12. The software resources of the multifunctional machine 1 include an engine control board 101, an OS 102, a JVM (Java (registered trademark) Virtual Machine) 103, an OSGi (Open Services Gateway Initiative) platform 104, bundles 105, and native code services 106. The software resources are stored in a memory device (i.e., storage device) 200 of the multifunctional machine 1. A CPU 201 of the multifunctional machine 1 performs processing procedures of these software resources to provide their intended functions.

The engine control board 101 controls the individual functions of the multifunctional machine 1 such as the plotter engine 11 and the scanner engine 12. The function of the engine control board 101 is provided to the OS 102 or the like through an engine I/F (interface).

The OS 102 is an operating system on which the JVM 103, the native code services 106, and the like run in parallel as processes. The JVM 103 converts byte codes specific to the Java (registered trademark) language into a native code that is executable on the OS 102, and executes the converted code. The OSGi platform 104 is a software platform that provides an environment in which software components created based on a Java-language-based open software component technology are executed, which is a standard technology provided by the OSGi alliance. On the OSGi platform 104, a Java-language software is implemented as a software component referred to as a “bundle”. A single bundle is comprised of a single JAR (Java Archive) file. Each bundle can be installed independently and dynamically, so that there is no need to reboot the apparatus. The bundles 105 illustrated in FIG. 1 are such bundles. As illustrated, there may be plural bundles 105. The native code services 106 may be implemented by use of the C language, for example, and are programs based on a native code that can be directly executed on the OS 101. As illustrated, there may be plural native code services 106. The native code services 106 provide various functions that may be shared by the bundles 105, for example. The native code services 106 are called (utilized) by the bundles 105 that run as threads on the JVM 103. Such calls may be implemented by use of a JNI (Java Native Interface), for example.

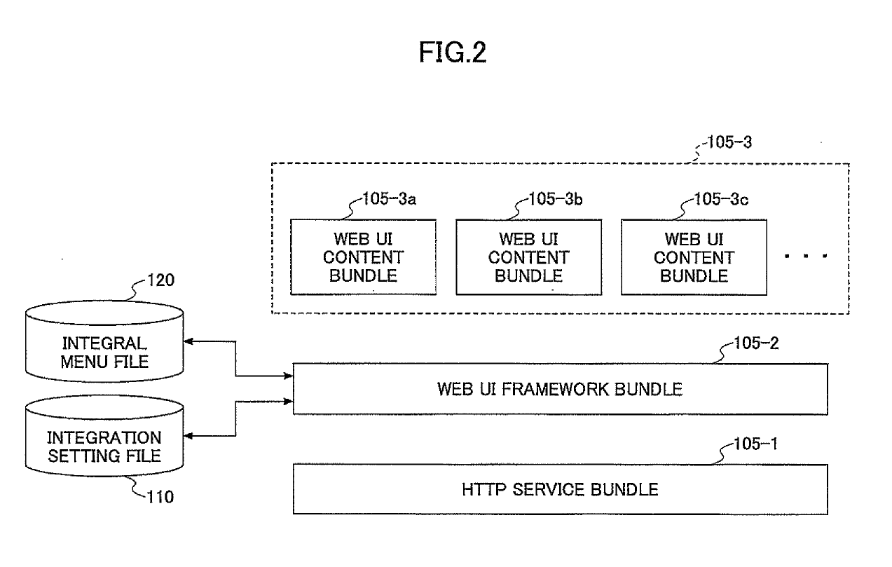

The bundles 105 among the software resources described above provide a Web site for the multifunctional machine 1. FIG. 2 is a drawing illustrating an example of the configuration of bundles that provide an integrated Web site according to the first embodiment.

FIG. 2 illustrates an HTTP service bundle 105-1, a Web UI framework bundle 105-2, and Web UI content bundles 105-3, which are individually referred to as Web UI content bundles 105-3a, 105-3b, 105-3c, and so on. These bundles correspond to the bundles 105 illustrated in FIG. 1. Namely, FIG. 2 illustrates the relationships (hierarchical structure) of the bundles for implementing a Web site among the bundles 105 illustrated in FIG. 1.

The HTTP service bundle 105-1 is a bundle 105 serving as an HTTP server (i.e., HTTP daemon). The HTTP service bundle 105-1 controls HTTP communications such as the receiving of HTTP requests from clients (e.g., Web browsers) and the transmission of HTTP responses to the clients.

Each of the Web UT content bundles 105-3 is a bundle 105 serving as a Web application. Namely, each of the Web UT content bundles 105-3 is assigned with a unique URL (Uniform Resource Locator). Each of the Web UT content bundles 105-3 executes its specific business logic in response to an HTTP request specifying the URL that is assigned thereto, and, then, displays a Web UT content (i.e., Web page such as HTML data) to present the results of the processing.

The Web UT framework bundle 105-2 is a bundle 105 that performs the process for providing a single Web site by integrating the plural Web UI content bundles 105-3 that are independent of each other. The integration of the Web UI content bundles 105-3 includes the management of information (e.g., session information, identification information, language (display language) information, and the like) that are common to the Web UI content bundles 105-3, the calling of the Web UI content bundles 105-3 (i.e., the distribution of HTTP requests) in response to URLs specified by HTTP requests, and the management of menu configuration information for the Web UI content bundles 105-3.

The distribution of HTTP requests is performed based on an integration setting file 110. The integration setting file 110 includes information indicative of one-to-one correspondences between the Web UI content bundles 105-3 and their URLs (such information will hereinafter be referred to as “URL correspondence information”). The Web UI framework bundle 105-2 refers to the integration setting file 110 to identify a Web UI content bundle 105-3 that corresponds to a URL specified by an HTTP request, and calls this Web UI content bundle 105-3 to let this Web UI content bundle 105-3 perform a process responsive to the HTTP request.

The menu configuration information defines the hierarchical structure of menus, and specifies one-to-one correspondences between displayed items (e.g., displayed character strings) and their URLs (i.e., the Web UI content bundles 105-3) for each menu. Such menu configuration information is stored in an integral menu file 120. Here, the term “menu” refers to a menu that is displayed on a Web page (i.e., menu page) for displaying one or more menus to allow the use of the Web UI content bundles 105-3.

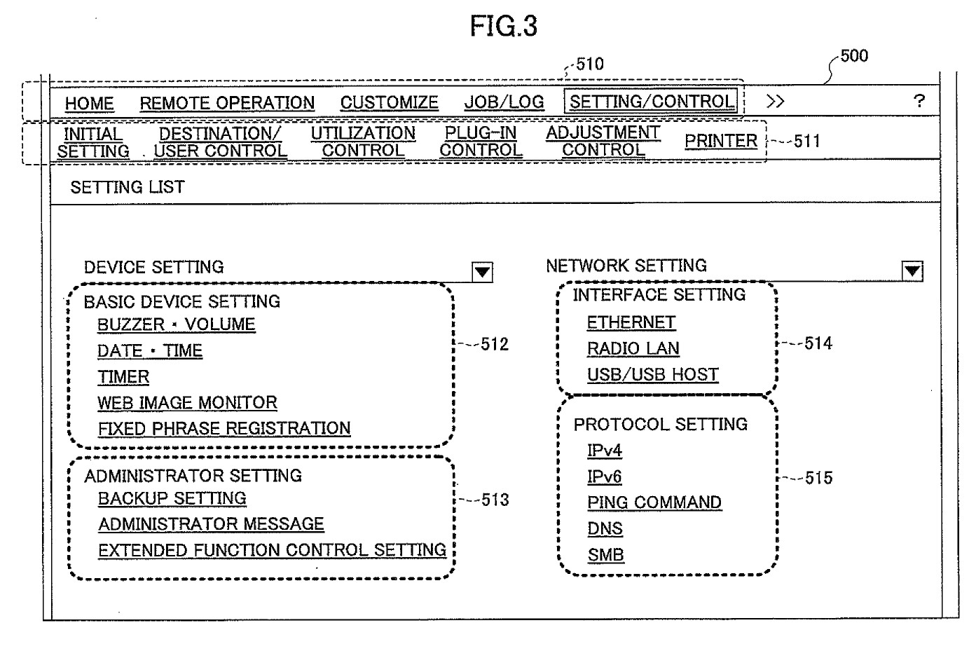

FIG. 3 is a drawing illustrating an example of a displayed menu page according to the first embodiment. On a menu page 500 illustrated in FIG. 3, menu items (i.e., “home”, “remote operation”, “customize”, “job/log”, and “setting/control”) included in a menu 510 are not the menu items for calling the Web UI content bundles 105-3, but are the menu items for navigating through the hierarchical structure of menus. Menus 511, 512, 513, 514, and 515, on the other hand, are each a set of menu items for calling the Web UI content bundles 105-3. The displayed contents of these menus vary depending on which one of the items is selected on the menu 510. Namely, there are hierarchical relationships (i.e., parent-child relationships) between the menu items of the menu 510 and the menus 511, 512, 513, 514, and 515. Further, there are hierarchical relationships (i.e., parent-child relationships) between the menus 511, 512, 513, 514, and 515 and the menu items contained therein. FIG. 3 illustrates the menu page 500 as appear when the “setting/control” item is selected on the menu 510.

In the example illustrated in FIG. 3, the menu configuration information defines the hierarchical relationships between the menu items of the menu 510 and the other menus, and also defines URLs for the menu items that constitute terminal nodes in the hierarchical tree structure.

The menu page 500 is generated by a Web UT content bundle 105-3 (e.g., Web UI content bundle 105-3a) that is associated with a URL of the menu page 500. This Web UI content bundle 105-3 uses the integral menu file 120 to generate the menu page 500.

The integration setting file 110 and the integral menu file 120 are stored in advance in an HDD (Hard Disk Drive) of the multifunctional machine 1.

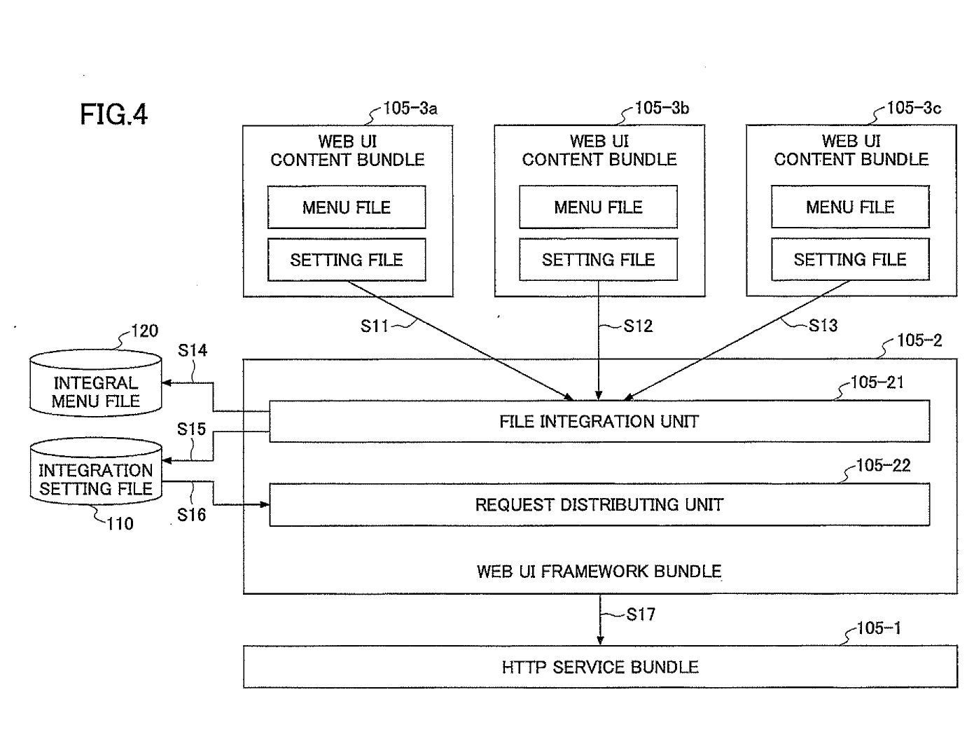

The integration setting file 110 and the integral menu file 120 are automatically generated and updated by the Web UI framework bundle 105-2. FIG. 4 is a drawing illustrating the process of generating an integration setting file and an integral menu file. As a premise, each Web UI content bundle 105-3 has a setting file and a menu file associated therewith. The setting file includes information (i.e., URL correspondence information) indicative of a one-to-one correspondence between the Web UI content bundle 105-3 (i.e., its identification name) and its URL. The menu file includes information indicative of the display contents and arrangement positions of menu items for the Web UI content bundle 105-3. The term “arrangement position” refers to a location within the hierarchical structure of the menu page 500.

Each Web UI content bundle 105-3 supplies its menu file and setting file to a file integration unit 105-21 of the Web UI framework bundle 105-2 (S11, S12, S13). Alternatively, the file integration unit 105-21 may actively acquire a menu file and a setting file from each Web UI content bundle 105-3.

The file integration unit 105-21 integrates the menu files collected from the Web UI content bundles 105-3 to generate the integral menu file 120 (S14). Further, the file integration unit 105-21 integrates the setting files collected from the Web UI content bundles 105-3 to generate or update the integration setting file 110 (S15). In so doing, the file integration unit 105-21 performs various checks including a check as to whether there are overlapping URLs between the Web UI content bundles 105-3. If there are overlapping URLs, the file integration unit 105-21 aborts the process of generating the integration setting file 110. The integration of menu files and setting files may be performed by serially arranging descriptions contained in these menu files and setting files.

A request distributing unit 105-22 of the Web UI framework bundle 105-2 acquires URL correspondence information from the generated or updated integration setting file 110 (S16). Then, the request distributing unit 105-22 registers (reports) the list of URLs (i.e., the list of URLs of the Web UI content bundles 105-3 to be integrated by the Web UI framework bundle 105-2) contained in the URL correspondence information to the HTTP service bundle 105-1 (S17).

In response to the receipt of an HTTP request (e.g., an HTTP request transmitted upon selecting a menu item on the menu page 500), the HTTP service bundle 105-1 reports this HTTP request to the request distributing unit 105-22 of the Web UI framework bundle 105-2 if the URL specified by the HTTP request is included in the list of URLs reported by the Web UI framework bundle 105-2. The request distributing unit 105-22 identifies a Web UI content bundle 105-3 that corresponds to the URL specified by the HTTP request according to the integration setting file 110, and calls this Web UI content bundle 105-3.

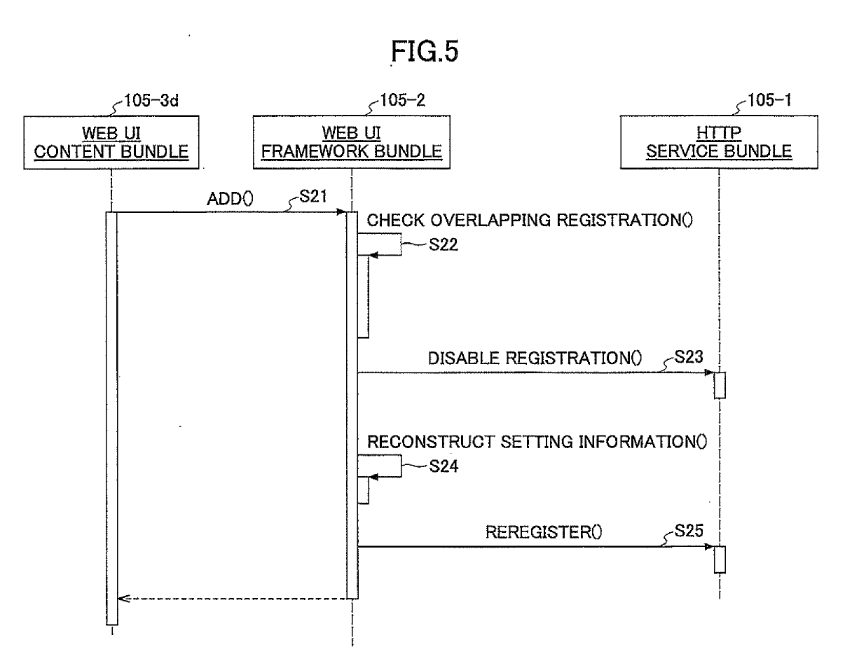

In the following, a description will be given of a process that is performed upon installing (i.e., adding) a new Web UI content bundle 105-3 during the operation of the multifunctional machine 1. FIG. 5 is a drawing illustrating a procedure that is performed upon adding a Web UI content bundle according to the first embodiment.

A new Web UI content bundle 105-3d, for example, is installed. Upon being installed, the Web UI content bundle 105-3d requests the file integration unit 105-21 of the Web UI framework bundle 105-2 to additionally register its menu file and setting file (S21). Thereafter, the file integration unit 105-21 checks whether there are overlapping URLs based on the setting file of the newly added Web UI content bundle 105-3d and the integration setting file 110 (S22). If there are overlapping URLs, the file integration unit 105-21 aborts the procedure, and displays a message prompting a change of URL or the like on the display panel.

If there are no overlapping URLS, the file integration unit 105-21 requests the HTTP service bundle 105-1 to disable the registered list of URLs (S23). In response, the list of URLs registered in step S17 and the like of FIG. 4 is disabled at the HTTP service bundle 105-1. Notification of an HTTP request directed to a URL contained in this list will thereafter be suspended.

The file integration unit 105-21 then adds the contents of the menu file and setting file of the Web UI content bundle 105-3d to the integral menu file 120 or the integration setting file 110 (S24). The request distributing unit 105-22 of the Web UT framework bundle 105-2 registers the list of URLs in the HTTP service bundle 105-1 based on the updated integration setting file 110 (S25). As a result, an HTTP request directed to the Web UI content bundles 105-3 on the Web UI framework bundle 105-2 is treated as a valid request.

According to the multifunctional machine 1 of the first embodiment described above, the Web UT content bundles 105-3 that are highly independent of each other are properly integrated to generate a single Web site.

In the following, a second embodiment will be described. With respect to the second embodiment, a description will be given of those points which are different from the first embodiment.

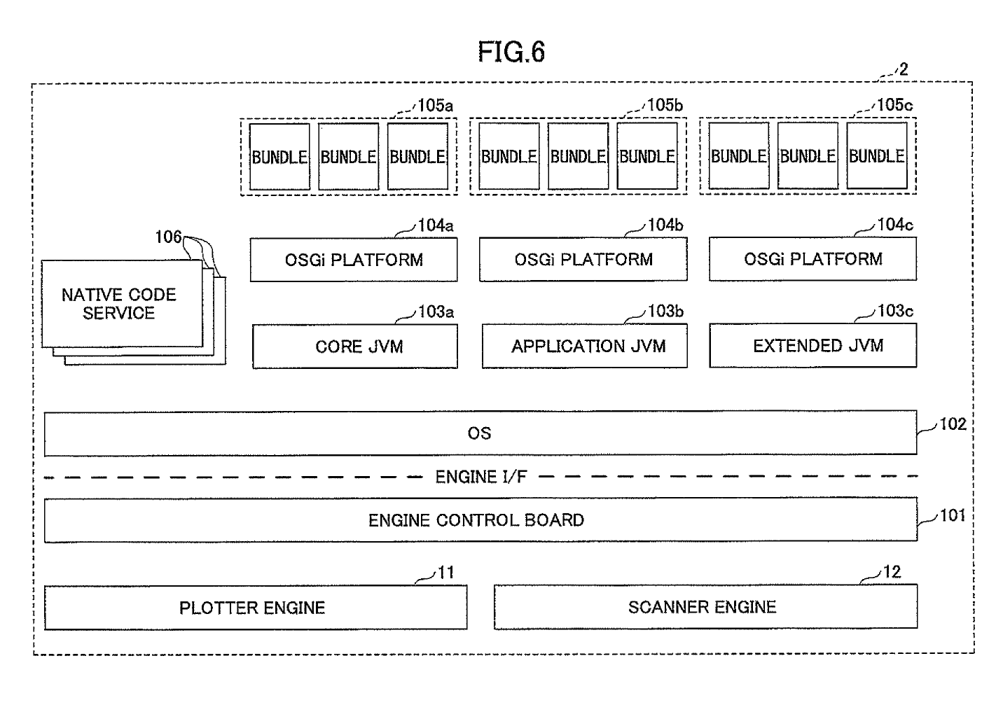

FIG. 6 is a drawing illustrating an example of the configuration of a program execution environment of an image forming apparatus according to the second embodiment. In FIG. 6, the same elements as those of FIG. 1 are referred to by the same numerals, and a description thereof will be omitted as appropriate.

As is illustrated, a multifunctional machine 2 includes three JVMs 103 that are a core JVM 103a, an application JVM 103b, and an extended JVM 103c. For each of the three JVMs 103, the configuration described in connection with FIG. 1 (i.e., the OSGi platform 104 and the bundles 105) are provided. The OSGi platform 104 and the bundles 105 for each JVM 103 are discriminated by adding “a”, “b”, or “c” at the end of the reference numerals.

The function (i.e., implemented contents) of each JVM 103 is basically the same. As a difference, however, each JVM 103 may have different access authority for accessing another JVM environment or the native environment. Specifically, the core JVM 103a may provide an execution environment for the most reliable bundle 105, which may be a bundle 105 that is created by the manufacturer of the multifunctional machine 2. The bundle 105 that runs on the core JVM 103a will hereinafter be referred to as “core bundle 105a” for the sake of convenience of explanation. The core bundle 105a can directly call (i.e., utilize) all the functions provided by the native code services 106 and the engine control board 101, for example. It should be noted, however, that some restrictions may be imposed on the use of the native code services 106 and/or the engine control board 101 by the core bundle 105a.

The application JVM 103b provides an execution environment for a bundle 105 that is less reliable than the core bundle 105a or for which access to the resources of the multifunctional machine 2 should be more restricted. The bundle 105 that runs on the application JVM 103b will hereinafter be referred to as “application bundle 105b” for the sake of convenience of explanation. The application bundle 105b can directly utilize the functions provided by the native code services 106. It should be noted, however, that greater restrictions than the restrictions for the core bundle 105a are imposed on the use of the native code services 106 by the application bundle 105b. Further, the application bundle 105b can directly utilize all or part of the functions of the core bundle 105a. It should be noted that calling across different JVM environments may be performed by use of RMI (Remote Method Invocation)-based descriptions known to those skilled in the art.

The extended JVM 103c provides an execution environment for a bundle 105 that is less reliable than the application bundle 105b or for which access to the resources of the multifunctional machine 2 should be more restricted. The bundle 105 that runs on the extended JVM 103c will hereinafter be referred to as “extended bundle 105c” for the sake of convenience of explanation. The extended bundle 105c can directly utilize the functions of the core bundle 105a and the application bundle 105b with the restrictions that are set in advance. The extended bundle 105c is not allowed to directly utilize the functions provided by the native code services 106.

As described above, the access authority (i.e., access right) of the bundles 105 in the multifunctional machine 2 are controlled on a JVM-environment-specific basis. FIG. 6 illustrates an example in which three JVMs 103 are provided. Accordingly, the security levels of the bundles 105 may be classified into three different levels depending on which one of the JVMs 103 allows the execution of a bundle of interest. Compared with a case in which access authority is controlled separately for each bundle 105, the above-noted arrangement can perform access control more easily with respect to each application. The number of JVMs 103 may be two, or may be equal to or greater than 4 depending on the specification of the hardware resources of the multifunctional machine 2. In the case of two JVMs, two different security levels can be provided. In the case of four or more JVMs, four or more security levels can be provided.

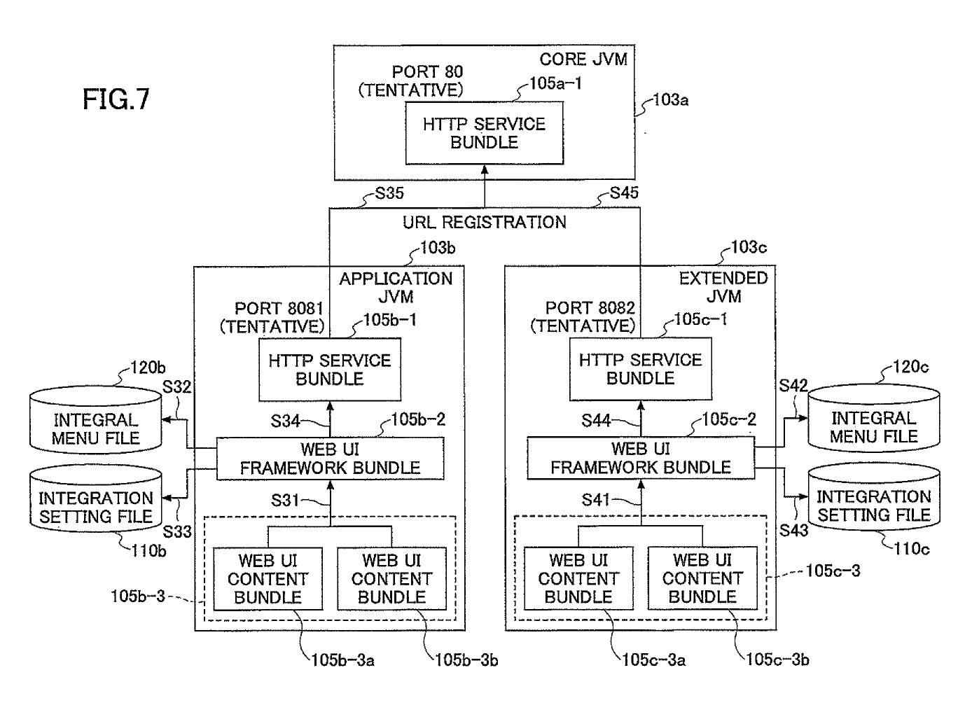

In the environment as described above, a Web site is provided by use of a bundle configuration as described below according to the second embodiment. FIG. 7 is a drawing illustrating an example of the configuration of bundles that provide an integrated Web site according to the second embodiment.

In FIG. 7, an HTTP service bundle 105a-1 is implemented by the core bundle 105a on the core JVM 103a. On the other hand, the configurations of the application JVM 103b and the extended JVM 103c are the same as those of the first embodiment. Namely, an HTTP service bundle 105b-1, a Web UI framework bundle 105b-2, and one or more Web UI content bundles 105b-3 are implemented on the application JVM 103b by the application bundle 105b. Further, an HTTP service bundle 105c-1, a Web UI framework bundle 105c-2, and one or more Web UI content bundles 105c-3 are implemented on the extended JVM 103c by the extended bundle 105c.

The function of each bundle 105 is the same as the function described in the first embodiment. The HTTP service bundles 105a-1, 105b-1, and 105c-1 have different port numbers for receiving an HTTP request. Only the port of the HTTP service bundle 105a-1 will be disclosed to the public (i.e., disclosed to the network).

In the second embodiment, there are two Web UI framework bundles 105-2 such as the Web UI framework bundle 105b-2 and the Web UI framework bundle 105c-2. The second embodiment thus may preferably have a mechanism to integrate two Web UI framework bundles 105-2. In the following, an example of such mechanism will be described.

By referring to FIG. 6 again, a description will be given of a process that is performed when generating the integration setting file 110 and the integral menu file 120.

Each Web UI content bundle 105b-3 on the application JVM 103b supplies its menu file and setting file to a file integration unit of the Web UT framework bundle 105b-2 (531). By the same token, each Web UI content bundle 105c-3 on the extended JVM 103c supplies its menu file and setting file to a file integration unit of the Web UI framework bundle 105c-2 (S41).

Subsequently, the Web UI framework bundle 105b-2 integrates the collected menu files to generate an integral menu file 120b (S32). Further, the Web UI framework bundle 105b-2 integrates the collected setting files to generate or update an integration setting file 110b (S15). By the same token, the Web UI framework bundle 105c-2 integrates the collected menu files to generate an integral menu file 120c (S42). Further, the Web UI framework bundle 105c-2 integrates the collected setting files to generate or update an integration setting file 110c (S43). In integrating the setting files, a check as to whether there are overlapping URLs is made in the same manner as in the first embodiment.

Subsequently, the Web UI framework bundle 105b-2 registers the list of URLs in the HTTP service bundle 105b-1 based on the integration setting file 110b (S34). Similarly, the Web UI framework bundle 105c-2 registers the list of URLs in the HTTP service bundle 105c-1 based on the integration setting file 110c (S44).

Thereafter, the HTTP service bundle 105b-1 reports the registered list of URLs to the HTTP service bundle 105a-1 on the core JVM 103a (S25) to request to distribute (i.e., deliver) HTTP requests that specify URLs contained in the list (which will hereinafter be referred to as “application URL list”) (S35). Similarly, the HTTP service bundle 105c-1 reports the registered list of URLs to the HTTP service bundle 105a-1 to request to distribute (i.e., deliver) HTTP requests that specify URLs contained in the list (which will hereinafter be referred to as an “extended URL list”) (S45).

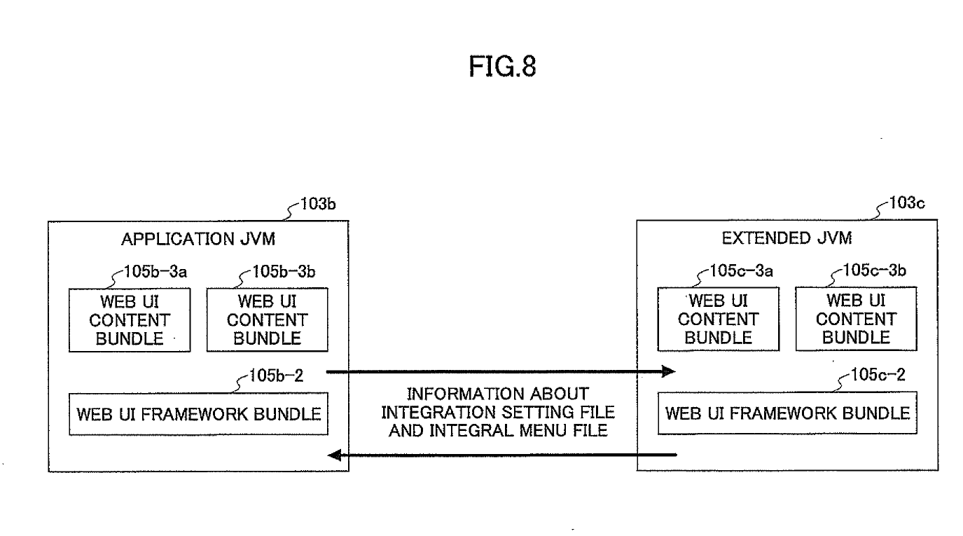

In the above description, the description of processes on the application JVM 103b and the description of processes on the extended JVM 103c have been provided as parallel descriptions. These processes on the respective JVMs 103, however, do not have to be synchronized with each other. As illustrated in FIG. 8, nonetheless, the Web UI framework bundle 105b-2 and the Web UI framework bundle 105c-2 exchange management information with each other by use of RMI (Remote Method Invocation) or the like at predetermined timing. This predetermined timing may be when the Web UI framework bundle 105b-2 or 105c-2 generates or updates the integration setting file 110 or the integral menu file 120. The management information described above is the information contained in the integration setting file 110 or the integral menu file 120.

With this arrangement, any given Web UT framework bundle 105-2 may generate a new integral menu file 120 by merging the contents (i.e., menu configuration information) of the existing integral menu file 120 kept under its own control with the contents of another integral menu file 120 kept under the control of another Web UI framework bundle 105-2. In this manner, the individual Web UI framework bundles 105-2 manage the integral menu files 120 having the same contents (i.e., share the menu configuration information). A Web UI content bundle 105-3 to generate the menu page 500 may be implemented on both of the two Web UI framework bundles 105-2. Even in such a case, the menu page 500 generated by these Web UI content bundles 105-3 will have the same configuration.

Further, any given Web UI framework bundle 105-2 may check whether there are overlapping URLs between the URLs registered in the integration setting file 110 kept under its own control with the URLs registered in the integration setting file 110 kept under the control of another Web UI framework bundle 105-2. Upon detecting an overlap, the overlapping URL may be displayed on the operation panel or the like to prompt a user to fix the problem. With this arrangement, the overlapping of URLs across different Web UI framework bundles 105-2 (i.e., across different JVMs 103) can be avoided.

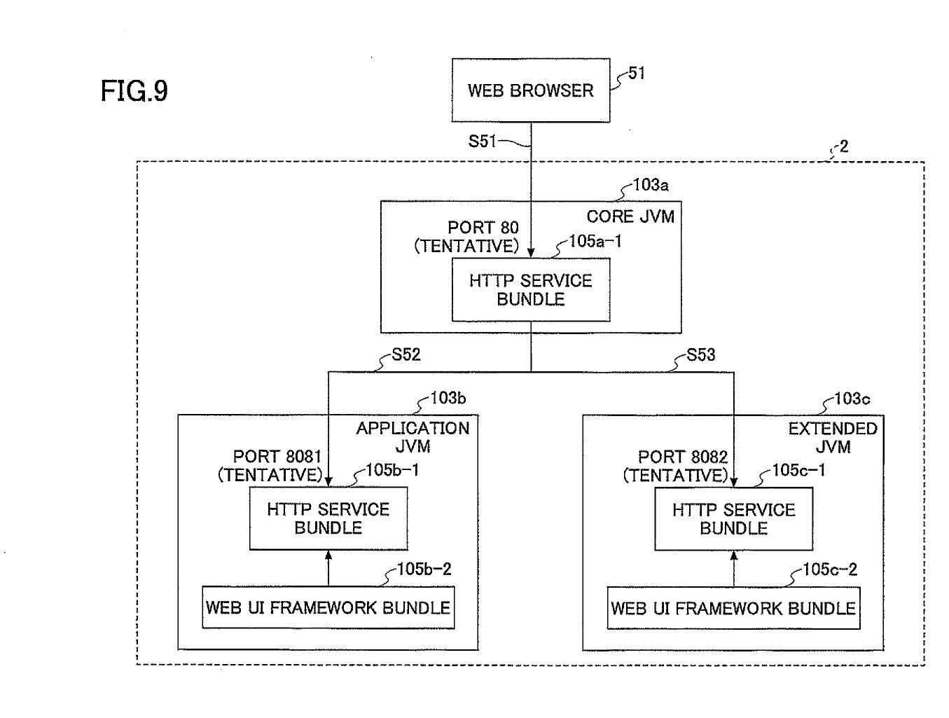

In the following, a description will be given of a process that is performed upon receiving an HTTP request. FIG. 9 is a drawing illustrating an example of a procedure that is performed upon receiving an HTTP request according to the second embodiment.

An HTTP request from a Web browser 51 is received by the HTTP service bundle 105a-1 on the core JVM 103a (S51). As was previously described, only the port of the HTTP service bundle 105a-1 is disclosed to the public. The HTTP service bundle 105a-1 identifies the destination of the HTTP request based on the URL specified in the received HTTP request and the application URL list or extended URL list. If the received URL is contained in the application URL list, the HTTP service bundle 105a-1 transfers the HTTP request to the HTTP service bundle 105b-1 (S52). If the received URL is contained in the extended URL list, on the other hand, the HTTP service bundle 105a-1 transfers the HTTP request to the HTTP service bundle 105c-1 (S53). The procedure that will be performed thereafter is the same as the procedure described in the first embodiment, and a description thereof will be omitted.

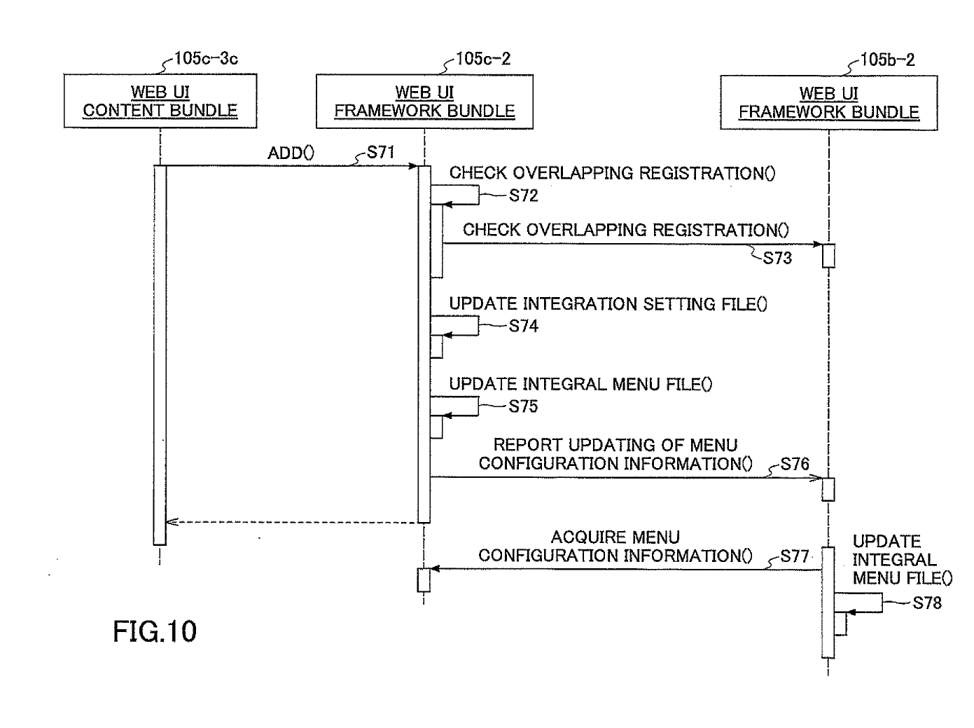

In the following, a description will be given of a process that is performed upon installing (i.e., adding) an extended bundle 105c relating to a new Web UI content bundle 105c-3 during the operation of the multifunctional machine 2. FIG. 10 is a drawing illustrating a procedure that is performed upon adding a Web UI content bundle according to the second embodiment.

A new Web UI content bundle 105c-3c, for example, may be installed on the extended JVM 103c. Upon being installed, the Web UI content bundle 105c-3c requests the Web UI framework bundle 105c-2 to additionally register its menu file and setting file (S71). Thereafter, the Web UI framework bundle 105c-2 checks whether there are overlapping URLs based on the setting file of the newly added Web UI content bundle 105c-3c and the integration setting file 110c (S72). Further, the Web UI framework bundle 105c-2 sends the setting file of the Web UI content bundles 105c-3c to the Web UI framework bundle 105b-2 to request a check as to whether there are overlapping URLs (S73). If there are overlapping URLs, the Web UT framework bundle 105c-2 aborts the procedure, and displays a message prompting a change of URL or the like on the display panel.

Subsequently, the Web UI framework bundle 105c-2 adds the contents of the menu file and setting file of the Web UI content bundle 105c-3c to the integration setting file 110c or the integral menu file 120c (S74, S75). Before and after the updating of the integration setting file 110c and the integral menu file 120c, the registered list of URLs corresponding to the HTTP service bundle 105c-1 is disabled and then reregistered in the same manner as in the first embodiment.

Subsequently, the Web UI framework bundle Ψc-2 notifies the Web UI framework bundle 105b-2 that the menu configuration information has been updated (S76). In response to the notice, the Web UI framework bundle 105b-2 acquires the menu configuration information (i.e., the menu configuration information stored in the updated integral menu file 120c) from the Web UI framework bundle 105c-2 (S77), and merges the acquired menu configuration information with the integral menu file 120b (S78).

According to the multifunctional machine 2 of the second embodiment described above, a single Web site integrated for the entirety of the multifunctional machine 2 can be generated even when the Web UI framework bundles 105-2 are implemented in a distributed manner in plural JVMs 103.

Further, the present invention is not limited to these embodiments, but various variations and modifications may be made without departing from the scope of the present invention.

The present application is based on Japanese priority application No. 2008-101867 filed on Apr. 9, 2008, with the Japanese Patent Office, the entire contents of which are hereby incorporated by reference.

What is claimed is:

1. An image forming apparatus, comprising:
a plurality of Web page generating units each configured to perform processing responsive to an HTTP request and to generate a Web page for displaying information about a result of the processing;
a menu information integrating unit configured to acquire from each of the Web page generating units information about URLs of the Web page generating units and information about menu items to be displayed for allowing the Web page generating units to be utilized, and configured to integrate the acquired information into a first storage file; and
a menu page generating unit configured to generate based on the first storage file a Web page inclusive of the menu items for allowing Web pages generated by the Web page generating units to be utilized.

2. The image forming apparatus as claimed in claim 1, further comprising:
a URL information integrating unit configured to acquire correspondence information indicative of a correspondence between a Web page generating unit and a URL from each of the Web page generating units and to integrate the acquired correspondence information into a second storage file; and
a request distributing unit configured to identify one of the Web page generating units corresponding to a URL specified by a received HTTP request and to cause the identified Web page generating unit to perform processing responsive to the received HTTP request.

3. The image forming apparatus as claimed in claim 2, wherein the URL information integrating unit is configured to check whether there are overlapping URLs based on the acquired correspondence information and to integrate the acquired correspondence information upon finding no overlapping URLs.

4. The image forming apparatus as claimed in claim 2, wherein in response to an installing of a program module relating to a new Web page generating unit, the menu information integrating unit newly acquires, from the new Web page generating unit, information about URL and information about menu items to be displayed, and adds the newly acquired information into the first storage file, and the URL information integrating unit newly acquires the correspondence information from the new Web page generating unit, and adds the newly acquired correspondence information into the second storage file.

5. A method for processing information in an image forming apparatus having a plurality of Web page generating units each configured to perform processing responsive to an HTTP request and to generate a Web page for displaying information about a result of the processing, the method comprising:
a menu information integrating step of acquiring from each of the Web page generating units information about URLs of the Web page generating units and information about menu items to be displayed for allowing the Web page generating units to be utilized, and integrating the acquired information into a first storage file; and
a menu page generating step of generating based on the first storage file a Web page inclusive of the menu items for allowing Web pages generated by the Web page generating units to be utilized.

6. The method as claimed in claim 5, further comprising:
a URL information integrating step of acquiring correspondence information indicative of a correspondence between a Web page generating unit and a URL from each of the Web page generating units, and integrating the acquired correspondence information into a second storage file; and
a request distributing step of identifying one of the Web page generating units corresponding to a URL specified by a received HTTP request, and causing the identified Web page generating unit to perform processing responsive to the received HTTP request.

7. The method as claimed in claim 6, wherein the URL information integrating step checks whether there are overlapping URLs based on the acquired correspondence information, and integrates the acquired correspondence information upon finding no overlapping URLs.

8. The method as claimed in claim 6, further comprising:
in response to an installing of a program module relating to a new Web page generating unit,
a step of newly acquiring, from the new Web page generating unit, information about URL and information about menu items to be displayed, and adds the newly acquired information into the first storage file, and
a step of newly acquiring the correspondence information from the new Web page generating unit, and adding the newly acquired correspondence information into the second storage file.

9. A machine-readable recording medium having a program stored therein to be executed by an image forming apparatus having a plurality of Web page generating units each configured to perform processing responsive to an HTTP request and to generate a Web page for displaying information about a result of the processing, the program comprising:
a menu information integrating step of acquiring from each of the Web page generating units information about URLs of the Web page generating units and information about menu items to be displayed for allowing the Web page generating units to be utilized, and integrating the acquired information into a first storage file; and
a menu page generating step of generating based on the first storage file a Web page inclusive of the menu items for allowing Web pages generated by the Web page generating units to be utilized.

10. The machine-readable recording medium as claimed in claim 9, the program further comprising:
a URL information integrating step of acquiring correspondence information indicative of a correspondence between a Web page generating unit and a URL from each of the Web page generating units, and integrating the acquired correspondence information into a second storage file; and
a request distributing step of identifying one of the Web page generating units corresponding to a URL specified by a received HTTP request, and causing the identified Web page generating unit to perform processing responsive to the received HTTP request.

11. The machine-readable recording medium as claimed in claim 10, wherein the URL information integrating step checks whether there are overlapping URLs based on the acquired correspondence information, and integrates the acquired correspondence information upon finding no overlapping URLs.

12. The machine-readable recording medium as claimed in claim 10, the program further comprising:
in response to an installing of a program module relating to a new Web page generating unit,
a step of newly acquiring, from the new Web page generating unit, information about URL and information about menu items to be displayed, and adds the newly acquired information into the first storage file, and
a step of newly acquiring the correspondence information from the new Web page generating unit, and adding the newly acquired correspondence information into the second storage file.
